(19) United States
(12) Patent Application Publication
(10) Pub. No.: US 2006/0088754 A1
(43) Pub. Date: Apr. 27, 2006

(54) Fuel cell system

(76) Inventors: Liqing Hu, Shanghai (CN); Xin Wu, Shanghai (CN)

Correspondence Address: RAYMOND Y. CHAN, 108 N. YNEZ AVE., SUITE 128, MONTEREY PARK, CA, 91754, US

(21) Appl. No.: 10/974,200

(22) Filed: Oct. 26, 2004

(51) Int. Cl. H01M 8/24; H01M 8/10

(52) U.S. Cl. 429/38; 429/37; 429/32

(57) ABSTRACT

The present discloses a fuel cell system comprising a plurality of individual fuel cells combined together to form an elongated fuel cell stack, wherein each of the individual fuel cells is divided into at least two separable isoelectric zones by insulated means, so that after the individual fuel cells are connected in series, the fuel cell stack is divided into at least two separable isoelectric parts, by connecting the separable isoelectric parts of the fuel cell stack in series, the fuel cell stack is capable of outputting a multiple increased voltage and a multiple decreased current.

### BACKGROUND OF THE PRESENT INVENTION

1. Field of Invention

The present invention relates to fuel cells, more particularly, relates to a kind of fuel cell which is capable of outputting multiple increased voltage while maintain a normal size and shape.

2. Description of Related Arts

Electrochemical fuel cell is a kind of electrochemical energy conversion device which is capable of converting the hydrogen and oxidant into electrical energy. The core part of this kind of device is a MEA (Membrane Electrode Assembly). The MEA includes a proton exchange membrane sandwiched by two porous sheets made of conductive material such as carbon tissue. At the same time, a layer of catalyst like metal platinum powder, adapted for facilitating the electrochemical reaction, are evenly and granularly provided on two layers of carbon tissue to form two catalytic interfaces. Furthermore, electrically conductible flow field plates are provided on two sides of the MEA to form a cathode and an anode, in such a manner, electron generated from the electrochemical reaction are capable of being lead out through an electrical circuit.

The anode of the MEA is supplied with fuel, such as hydrogen, for initiating the electrochemical reaction. The fuel is forced through the porous and diffused carbon tissue, and is capable of being deionized on the catalytic interface for the loss of electrons to generate positive ions. Moreover, positive ions are capable of transferably penetrating the proton exchange membrane to reach the cathode. On the other hand, an oxidant-containing gas, such as air, is supplied to the cathode of the MEA. Accordingly, the oxidant-containing gas is able to penetrate the porous and diffused carbon tissue to be ionized for the addition of the electrons to generate negative ions. Finally, the positive ions transferred from the anode will meet the negative ions to form reaction product.

In the electrochemical fuel cells which employ the hydrogen as the fuel and oxygen containing air as the oxidant, the electrochemical reaction on the anode generates hydrogen positive ions (protons). The proton exchange membrane is capable of facilitating the hydrogen positive ions migrate from the anode to the cathode. In addition, the proton exchange member has another function as a separator for blocking hydrogen containing air flow from being directly contacted with the oxygen containing air flow so as to prevent the mixture of hydrogen and oxygen as well as the explosive reaction.

The electrochemical reaction on the cathode side of fuel cell generates negative ions by obtaining the electrons. As a result, the negative ions generated on the cathode side will attract the positive ions transferred from the anode side to form water molecule as reaction product. In the electrochemical fuel cells which utilized the hydrogen as the fuel and oxygen containing air as oxidant, the electrochemical reaction is expressed by the following formula:
Anode: H₂→2H⁺+2e
Cathode: ½O₂+2H⁺+2e→H₂O

In the typical proton exchanging membrane fuel cell system, the MEA is disposed between two electrically conductible electrode plates, namely anode plate and cathode plate, wherein the contacting interface of each electrode plate at least defines one flowing channel or groove. The flowing channel or groove could be embodied by conventional mechanical method such as pressure casting, punching, and mechanical milling. The electrode plate could be embodied as metal electrode plate or graphite electrode plate. So the flowing channels defined on the electrode plate are capable of directing fuel and oxidant into anode side and cathode side respectively positioned on opposite side of the MEA. For a single fuel cell structure, only one MEA is provided and disposed between an anode plate and a cathode plate. Here, the anode plate and the cathode plate not only are embodied as current-collecting device, but also as a supporting device for securely holding the MEA. The flowing channels defined on the electrode plate are capable of delivering fuel and oxidant to the catalytic interfaces of the anode and cathode, and removing the water discharged from the electrochemical reaction of fuel cell.

To increase the overall power output of the proton exchanging membrane fuel cell, two or more fuel cells are electrically connected in series with a stacked manner or a successive manner to form a fuel cell stack. In such a stacked manner, each electrode plate comprises flowing channels defined on opposite side of plate respectively wherein one side of the electrode plate is applied as an anode plate contacting with the anode interface of a MEA, while another side of the electrode plate is applied as a cathode plate contacting with the cathode interface of an adjacent MEA. That is to say, one side of such electrode plate serve as an anode plate for one fuel cell and the other side of plate serve as a cathode plate for the adjacent cell fuel. Within the art, this kind of structure is called bipolar plate structure. Commonly, a plurality of individual fuel cells are connected in series to form above mentioned fuel cell stack, wherein a pair of manifold ending plates, namely the front manifold bus plate and the rear manifold bus plate are disposed at two ends of the fuel cell stack, and at least one attaching means adapted for holding two manifold ending plates is provided for securely sandwiching the fuel cell stack between two manifold ending plates.

Conclusively, a typical fuel cell stack further comprises a first manifold which has a first inlet and a first outlet adapted for evenly dispersing a fuel, such as hydrogen, methanol, alcohol, natural gas, and hydrogen rich gas reformed from gasoline into the anode flowing channel defined on the anode plate; a second manifold which has a second inlet and a second outlet adapted for evenly dispersing oxidant, such as oxygen and air, into the cathode flowing channel defined on the cathode plate; a third manifold which has a third inlet and a third outlet adapted for delivering coolant like water into the fuel cell stack for absorbing the heat generated from the electrochemical reaction inside the fuel cell stack as a radiation medium; wherein the first outlet and second outlet are also adapted for leading out the water generated from the electrochemical reaction. Commonly, all above mentioned inlets and outlets are defined on one of the manifold bus plate or two opposite manifold ending plates.

It has been practiced in the art to use such fuel cell stack as power system for propelling vehicles and ships, and operating other electrically operated machines such as portable generators and fixed generators.

It is noted that the current output of a proton exchange membrane fuel cell is primarily determined by the working area of MEA. For instance, under a 0.5 ampere/(per square centimeter of MEA) electrical current density, a fuel cell having 200 square centimeter working MEA is able to output 100 ampere current. On the other hand, the voltage output of a proton exchange membrane fuel cell stack is highly correlated with the quantity of the individual fuel cells for building up the fuel cell stack. To increase the overall voltage output, a plurality of individual fuel cells, each of which is capable of outputting a 0.5 to 1 electrical voltage, must be electrically connected in series to form a fuel cell stack.

Referring to FIG. 1 to FIG. 3, the electrode flow field plate, MEA, and the fuel stack according to above description are illustrated. Since the proton exchange membrane fuel cells are required to be applicable under various power range, the designers must consider and evaluate different factors such as working area of MEA, size and shape of electrode flow field plate, and quantity of the individual fuel cells for building up the fuel cell stack, etc.

This is due to the fact that the height and width of a fuel cell stack, as well as the current output of a fuel cell stack are determined by the size of electrode flow field plate and working area of the MEA. Meanwhile, the length and output voltage of a fuel cell stack are determined by the quantity of individual fuel cells for building up the fuel cell stack.

It is witnessed that the famous international company, Ballard Power System, had developed some type of fuel cell stacks embodied the above mentioned designing concept to satisfy some special applications, such as a high power generator. For example, the Mark-5 type fuel cell stack of Ballard was designed to embody a bigger size of width and height of a fuel cell stack wherein the height and width are around 20 centimeters. At the same time, another type fuel cell stack of Ballard Power System, which is used as small power generator, provided an entirely different designing ideal, the width and height of this type of fuel cell stack is relatively small (less than 5 centimeter), while its length is embodied as long as several tens centimeters as a result of increased quantity of individual fuel cells to increase the voltage output.

In short, the above mentioned designing principle is to guarantee that a fuel cell stack is capable of outputting adaptive current and voltage under different circumstances. Nevertheless, the fuel cell stacks designed according to the above designing principles suffered unconquerable drawbacks when applied in some particular applications.

1. According to the above mentioned designing principles, when the fuel cell stack is required to provide a large power output, the output voltage and output current are required to be increased. However, for some reasons, like packaging and shipment difficulties, the length of a fuel cell stack is limitedly defined. That is to say, the numbers of fuel cell units combined together to form a fuel cell stack could not be unlimitedly increased. Therefore, to offset this limitation, the output current is increased. Accordingly, it is seen that the height and width of the fuel cell stack were increased to increase the output current. Sometimes, the output current could be reach as high as a couple of hundreds amperes. Unfortunately, a lot of electrical energy has been lost during the large current outputting process. This is mainly due to the fact that the inherent impedance of the fuel cells and joints of electrical lines would generate heats which consume a lot of electrical energy so as to result a lower efficiency of the fuel cell stack

2. In addition, according to the above mentioned designing principles, when the fuel cell stack is required to provide a higher voltage output, the current output of the fuel cell stack is obliged to be reduced. As a result, the height and width of the fuel cell stack must be reduced, and the quantity of individual fuel cells combined together for building up the fuel cell stack will be inevitably increased. However, this prolonged fuel cell stack will result to a tough assembly, as well as waste more raw materials.

### SUMMARY OF THE PRESENT INVENTION

A main object of the present invention is to provide a fuel cell system which is able to overcome above mentioned drawbacks thereby facilitating the fuel cell stacks to output a multiple increased voltage while maintain a normal size and shape.

Accordingly, to achieve the above mention object, the present invention provides a fuel cell system, comprising:

a fuel cell stack which comprises a plurality of individual fuel cells alignedly connected together, each of the individual fuel cells comprises a pair of electrode flow field plates each of which having a conductible area, a MEA sandwiched between two electrode flow field plates comprising a proton exchanging membrane, and two layer of carbon tissues provided on either side of the proton exchanging membrane for applying catalysts to form an anode and a cathode respectively contacting with electrode flow field plates so as to define an electrically conductible portion in the MEA which is sized and shaped matching the conductible area of the electrode flow field plates;

a pair of manifold ending plates disposed on two ends of the fuel cell stack;

compression means for exerting a compressive force on manifold ending plates to securely hold the fuel cell stack between the two manifold ending plates; and

at least a pair of current collectionplates disposed on two end portions of the fuel cell stack for collecting a current output from the fuel cell stack;

wherein each individual fuel cell is divided into at least two separable isoelectric portions by insulated means,

wherein the electrically conductible portion defined on each MEA is further divided into at least two separable isoelectric portion by insulated means, and the electrically conductible area defined on each electrode flow field plate is divided into at least two separable isoelectric areas correspondingly matched with the separable isoelectric portion so that each individual fuel cell is divided into at least two separable portions;

These and other objectives, features, and advantages of the present invention will become apparent from the following detailed description, the accompanying drawings, and the appended claims.

### BRIEF DESCRIPTION OF THE DRAWINGS

FIG. 1 is a schematic view of an electrode flow field plate of prior art.

FIG. 2 is a schematic view of a MEA (Membrane Electrode Assembly) of prior art.

FIG. 3 is a schematic view of a fuel cell stack of prior art.

FIG. 4 is a schematic view of the electrode flow field plate according to the first preferred embodiment of the present invention.

FIG. 5 is a schematic view of the MEA according to the first preferred embodiment of the present invention.

FIG. 6 is a schematic view of the fuel cell system according to the first preferred embodiment of the present invention.

### DETAILED DESCRIPTION OF THE PREFERRED EMBODIMENTS

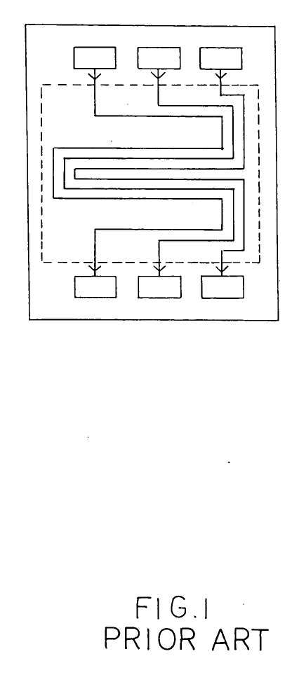

Referring to FIG. 1 to FIG. 3, a conventional fuel cell stack of the prior art is illustrated. Commonly, a fuel cell stack comprises a plurality of individual fuel cells alignedly connected in series to form the fuel cell stack, each of the individual fuel cells comprises a pair of electrode flow field plates both of which having a conductible area as shown in FIG. 1, and a MEA (Membrane Electrode Assembly) sandwiched between the two electrode flow field plates.

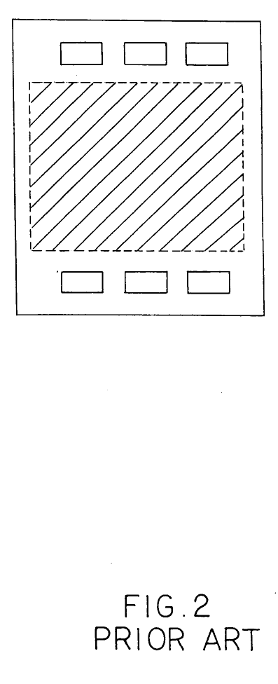

Meanwhile, the MEA includes a proton exchanging membrane, and two layers of carbon paper provided on either side of the proton exchanging membrane for applying catalysts to form an anode and a cathode. As a result, when the MEA is sandwiched between the two electrode flow field plates, the anode and the cathode are respectively contacting with electrode flow field plates. As shown in FIG. 2, an electrically conductible portion in the MEA which is sized and shaped matching the conductible area of the electrode flow field plates will be defined on the MEA.

Furthermore, a fuel cell stack comprises a pair of manifold ending plates disposed on two ends of the fuel cell stack and compression means for exerting a compressive force on manifold ending plates to securely hold the fuel cell stack between the two manifold ending plates.

Commonly, a fuel cell stack comprises at least a pair of current collectionplates disposed on two end portions of the fuel cell stack for electrically connecting with each individual fuel cell within the fuel cell stack so as to collect a current output from the fuel cell stack.

According to the first preferred embodiment of the present invention, each individual fuel cell within the fuel cell stack is further divided into at least two separable isoelectric portions by insulated means. As shown in FIG. 1, the conductible area of the electrode flow field plate is circumvented by the dotted line, preferably, the remaining portion of the electrode flow field plate is insulated. In the same way, as shown in FIG. 2, the corresponding portion defined on the MEA is delimited by the dotted line, and preferably, the remaining portion of the MEA is insulated.

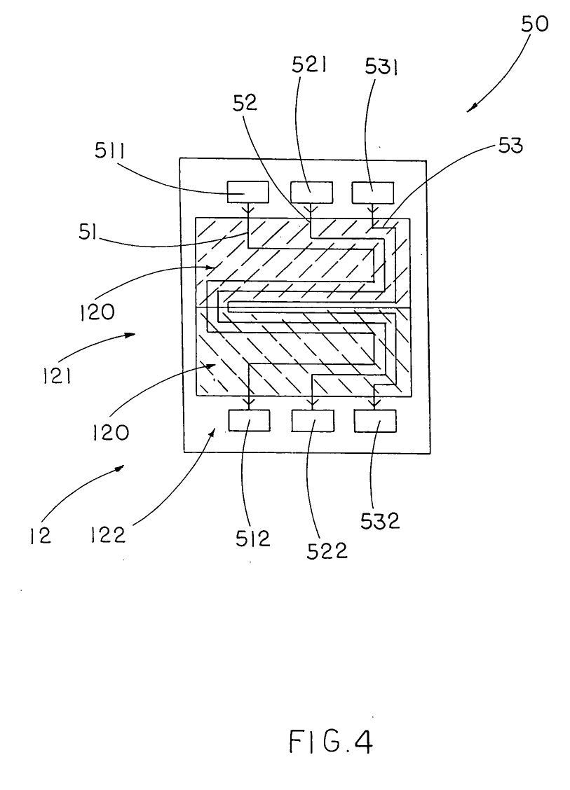

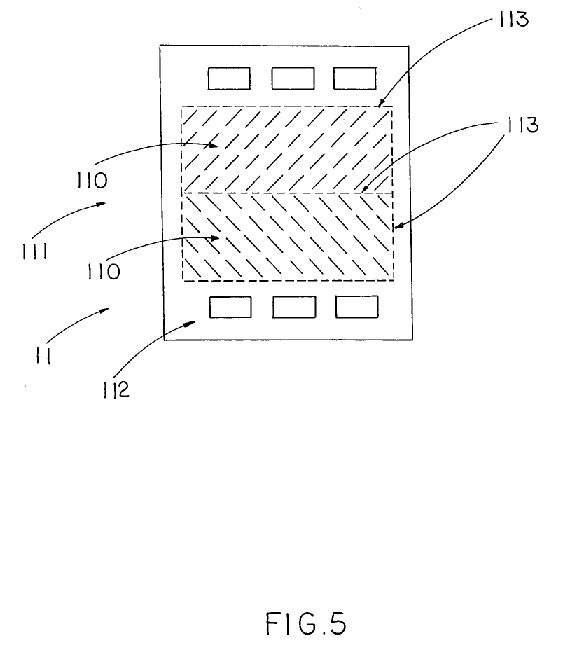

According to the first preferred embodiment, to multiply the voltage output of the fuel stack, the conductible area defined on the electrode flow field plate and conductible portion defined on the MEA are divided into at least two separable isoelectric areas by insulating means as shown in FIG. 4 and FIG. 5.

This is to say that the electrically conductible portion defined on each MEA is divided into at least two separable isoelectric portion by insulated means, and the electrically conductible area defined on each electrode flow field plate is also divided into at least two separable isoelectric areas correspondingly matched with the separable isoelectric portion so that each individual fuel cell is divided into at least two separable isoelectric zones.

It is noted that insulating means could be various binding materials, such as plastic resin, rubber and so on.

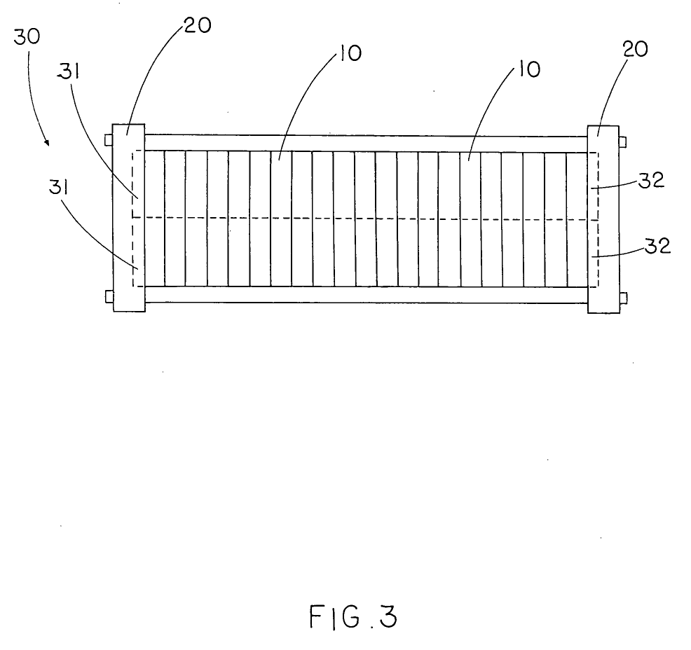

Therefore, to form a fuel cell stack, a plurality of individual fuel cell must be combined together as shown in FIG. 3. According to the first preferred embodiment of the present invention, the fuel cell stack combined by the individual fuel cells, each of which is divided into at least two separable isoelectric zones, is divided into two conductible parts. What is more, since a pair of current collection plates is provided for respectively collecting a current from the anode and cathode, here, at least two pairs of current collection plates, namely the first pair and the second pair, are provided at two end portion of the fuel cell stack for respectively collecting a current from two separable isoelectric parts of the fuel cell stack.

Afterwards, the first pair of current collection plates and the second pair of current collection plates are connected in series. As a result, the output current of the fuel cell stack is decreased to the half, while the voltage output of the fuel cell stack is twice as much as its original voltage output.

It is worth to mention the number of the current collection plats is correspondingly matched how many isoelectric zones being divided within a fuel cell stack. For example, if the individual fuel cell within a fuel cell stack is divided into four separable isoelectric zones, four pairs of current collection plates will be required for respectively current from four separable isoelectric zones. So, if the individual fuel cell is divided into three separable isoelectric zones, the voltage output of the fuel cell stack will be tripled.

Finally, it is worth to mention that the individual fuel cell within a fuel cell stack could be divided into a plurality of separable isoelectric zones according to the desire of users. Since the electrode flow field plates comprises a specific profile, the separable zones could not be evenly divided. However, the divided zones of an individual fuel cell must be isoelectric, i.e. the working current pass through the divided zones must be kept the same.

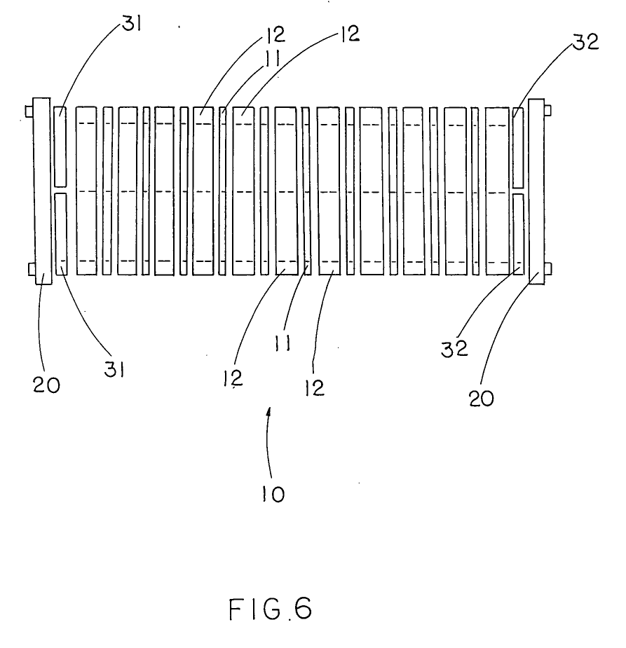

Referring to FIG. 6, the fuel cell stack according to the first preferred embodiment of the present invention is illustrated. The fuel cell stack 1 comprises a plurality of individual fuel cells 10 combined together for form the elongated fuel cell stack 1, each of the individual fuel cells comprises a MEA b having a proton exchange membrane and two layers of carbon papers provided on either side of the proton exchange membrane for applying catalysts to the proton exchange membrane, a pair of electrode flow field plates a provided on either side of MEA b for sandwiching the MEA therebetween, and a pair of current collectionplates c disposed at two end portion of the fuel cell unit 10 for electrically connecting the fuel cells 10 within the fuel cell unit 10.

The present invention further provides a detailed embodiment for illustrating the designing concept. The fuel cell stack to be tested comprises 20 individual fuel cells combined together, a pair of current collection plates, and a pair manifold ending plates.

According to the first preferred embodiment, the fuel cell stack is supplied hydrogen as fuel and air as oxidant, both of which are provided with 0.5-2 atmospheric pressure. Each of MEA is provided with 280 square centimeter working area, and the electrode flow filed plate is sized with 206 centimeter height, 206 centimeter width, and 5 centimeter thickness. The working temperature is set with 76° C.

At the beginning, it is detected that each of individual fuel cell is capable of outputting a 0.6V voltage under a 0.8 A/per square centimeter electrical current, and the fuel cell stack is capable of outputting a 12V voltage, a 224 ampere current output.

According to the present invention, each of individual fuel cell within the fuel cell stack is further divided into at least two separable isoelectric zones by insulating means, that is to say, the electrode flow field plate and the MEA of an individual fuel cell will be divided into two separable isoelectric parts. Accordingly, the current collection plates are divided into two parts correspondingly matched with two separable zones of individual fuel cells. After the separated current collection plates are connected in series, the primary object of the present invention should be achieved. That is to say, the fuel cell stack is divided into two individual fuel cell stacks connected in series.

Finally, the restructured fuel cell stack according to the first preferred embodiment is rechecked. It is viewed that the voltage output of this restructured fuel cell stack is capable of outputting a 24V voltage, which is twice as much as before. At the same time, the current output is reduced to 112 ampere, which is half as much as before. Therefore, the present invention provides a fuel cell system which is able to provide a multiple decreased voltage output, while maintain a normal size and shape.

For further illustration, the individual fuel cell within the fuel cell is divided into four separable isoelectric zones by insulating means, so that the fuel cell stack is divided into four individual fuel cell stack connected in series. The output voltage is quadrupled reaching an extent 48V, while the output current is further reduced to 56 ampere.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fuel cell system, comprising:
a plurality of individual fuel cells combined together to form an elongated fuel cell stack, each of said individual fuel cells comprises a pair of electrode flow field plates each of which defining a conductible area, a MEA sandwiched between said two electrode flow field plates, wherein said MEA comprises a proton exchanging membrane, and two layers of carbon paper provided on either side of the proton exchanging membrane for applying catalysts to form an anode and a cathode, and to define an electrically conductible portion on said MEA which is sized and shaped matching said conductible area of said electrode flow field plates;
a pair of manifold ending plates disposed on two ends of the fuel cell stack;
compression means for exerting a compressive force on manifold ending plates to securely hold said fuel cell stack between said two manifold ending plates; and
at least two pairs of current collection plates disposed on two end portions of said fuel cell stack for collecting a current output from the fuel cell stack;
wherein each individual fuel cell is divided into at least two separable isoelectric zones by insulated means, so that after said individual fuel cells are connected in series, said fuel cell stack is divided into at least two separable isoelectric parts, by connecting said separable isoelectric parts of said fuel cell stack in series, said fuel cell stack is capable of outputting a multiple increased voltage and a multiple decreased current.

2. The fuel cell system, as recited in claim 1, wherein said electrically conductible portion defined on each of said MEA is divided into at least two separable isoelectric portions by said insulated means.

3. The fuel cell system, as recited in claim 1, wherein said electrically conductible area defined on each of said electrode flow field plate is divided into at least two separable isoelectric areas by said insulated means, said electrically conductible area is correspondingly matched with said separable isoelectric portion so that each said individual fuel cell is divided into at least two said separable zones;

4. The fuel cell system, as recited in claim 2, wherein said electrically conductible area defined on each of said electrode flow field plate is divided into at least two separable isoelectric areas by said insulated means, said electrically conductible area is correspondingly matched with said separable isoelectric portion so that each said individual fuel cell is divided into at least two said separable zones;

5. The fuel cell system, as recited in claim 1, wherein said insulted means includes plastic resins.

6. The fuel cell system, as recited in claim 2, wherein said insulted means includes plastic resins.

7. The fuel cell system, as recited in claim 4, wherein said insulted means includes plastic resins.

8. The fuel cell system, as recited in claim 1, wherein said two pairs of current collection plates are respectively connected with said two separable isoelectric parts of said fuel cell stack, so that by connecting said two pairs of current collection plates in series, said fuel cell stack is capable of outputting a multiple increased voltage and a multiple decreased current.

9. The fuel cell system, as recited in claim 2, wherein said two pairs of current collection plates are respectively connected with said two separable isoelectric parts of said fuel cell stack, so that by connecting said two pairs of current collection plates in series, said fuel cell stack is capable of outputting a multiple increased voltage and a multiple decreased current.

10. The fuel cell system, as recited in claim 4, wherein said two pairs of current collection plates are respectively connected with said two separable isoelectric parts of said fuel cell stack, so that by connecting said two pairs of current collection plates in series, said fuel cell stack is capable of outputting a multiple increased voltage and a multiple decreased current.

11. The fuel cell system, as recited in claim 7, wherein said two pairs of current collection plates are respectively connected with said two separable isoelectric parts of said fuel cell stack, so that by connecting said two pairs of current collection plates in series, said fuel cell stack is capable of outputting a multiple increased voltage and a multiple decreased current.

12. The fuel cell system, as recited in claim 1, wherein said pair of current collection plates is numbered based on a predetermined number of parts of said fuel stack being divided.

13. The fuel cell system, as recited in claim 2, wherein said pair of current collection plates is numbered based on a predetermined number of parts of said fuel stack being divided.

14. The fuel cell system, as recited in claim 4, wherein said pair of current collection plates is numbered based on a predetermined number of parts of said fuel stack being divided.

15. The fuel cell system, as recited in claim 7, wherein said pair of current collection plates is numbered based on a predetermined number of parts of said fuel stack being divided.
